(19) United States
(12) Patent Application Publication
(10) Pub. No.: US 2019/0236093 A1
(43) Pub. Date: Aug. 1, 2019

(54) GRAPH DATABASE FOR MEDIA CONTENT SEARCH

(71) Applicant: Caavo Inc, Milpitas, CA (US)

(72) Inventors: Sravan K. Andavarapu, Jeypore (IN); Amrit P. Singh, Bangalore (IN); Vinod K. Gopinath, Bangalore (IN); Ashish D. Aggarwal, Stevenson Ranch, CA (US)

(21) Appl. No.: 16/258,057

(22) Filed: Jan. 25, 2019

(30) Foreign Application Priority Data
Jan. 26, 2018 (IN) 201841003132

(51) Int. Cl. G06F 16/483; G06F 16/432; H04H 60/72; H04N 21/482

(52) U.S. Cl. CPC G06F 16/483; H04N 21/482; H04H 60/72; G06F 16/432

(57) ABSTRACT

Embodiments are described herein for enabling fast and efficient media content searches across a wide variety of content providers using a graph database. For instance, metadata may be collected from different metadata sources. A graph database is generated that stores and organizes the metadata based on attributes of the metadata and the relationships therebetween. For example, each attribute is assigned to a node of the graph database. The nodes may be connected via an edge that represents a relationship between the nodes. Attributes of metadata retrieved from a first metadata source are associated with attributes of metadata retrieved from a second metadata source. When receiving a query, the graph database is traversed for media content items to recommend to a user. The media content items recommended to the user include items from different content providers that are determined based on the traversal of the nodes of the graph database.

### CROSS-REFERENCE TO RELATED APPLICATIONS

This application claims priority to Indian Provisional Patent Application No. 201841003132, filed Jan. 26, 2018, the entirety of which is incorporated by reference herein.

### BACKGROUND

### Technical Field

The subject matter described herein relates to building and using a graph database to improve the efficiency of media content searches.

### Description of Related Art

The number of entertainment sources is an ever-growing list. Furthermore, the availability of media content (movies, shows, music, etc.) from different online sources consumed by the user on different endpoints (TVs, computers, mobiles, etc.) is also growing rapidly. Thus, due to the influx of information, it is a challenge to both catalog information/metadata associated with media content and enable quick and easy searching of this information/metadata.

### BRIEF SUMMARY

Methods, systems, and apparatuses are described for using a graph database to improve the efficiency of media content searches, substantially as shown in and/or described herein in connection with at least one of the figures, as set forth more completely in the claims.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 depicts a system that uses a graph database for enabling a media content search in accordance with an example embodiment.

FIG. 2 depicts a system that uses a graph database for enabling a media content search in accordance with an example embodiment.

FIGS. 3A-3C depict examples graphs of a graph database in accordance with example embodiments.

FIG. 4 depicts an example graph of a graph database in accordance with another example embodiment.

FIG. 5 depicts a flowchart of a method for using a graph database for enabling a media content search in accordance with an example embodiment.

FIGS. 6A and 6B depict examples graphs of a graph database in accordance with example embodiments.

FIG. 7 depicts a flowchart of a method for using a graph database to identify content providers for media content items in accordance with an example embodiment.

FIGS. 8A-8B depict example graphs of a graph database in accordance with example embodiments.

FIG. 9 is a block diagram of an example computer system that may be used to implement various embodiments.

Embodiments will now be described with reference to the accompanying drawings.

### DETAILED DESCRIPTION

### I. INTRODUCTION

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described herein. Any section/subsection headings provided herein are not intended to be limiting. Embodiments are described throughout this document, and each embodiment may be eligible for inclusion within multiple different sections or subsections. Furthermore, it is contemplated that the disclosed embodiments may be combined with each other in any manner. That is, the embodiments described herein are not mutually exclusive of each other and may be practiced and/or implemented alone, or in any combination.

### II. EXAMPLE EMBODIMENTS

Embodiments are described herein for a media content search system that enables fast and efficient media content searches across a wide variety of content providers using a graph database. For instance, metadata may be collected from a plurality of different metadata sources. A graph database may be generated that stores and organizes the metadata based on attributes of the metadata and the relationships therebetween. For example, each attribute (e.g., an identifier of the media content, a genre of the media content, a credit associated with the media content, etc.) may be assigned to a node of the graph database. The nodes may be connected via an edge that represents a relationship between the nodes. Attributes of metadata retrieved from a first metadata source may be associated with attributes of metadata retrieved from a second metadata source. For instance, common or equivalent attributes may be assigned to the same node. When receiving a query, the graph database may be traversed for media content items to recommend to a user. The media content items recommended to the user may include items from different content providers that are determined based on the traversal of the nodes of the graph database.

By associating common metadata attributes obtained from different metadata sources into a single graph database, the number of searchable media content items and the number of relevant media content items that can be recommended are expanded.

Additionally, using a graph database advantageously results in a much faster and efficient search for media content items than compared to other techniques, such as relational database-related techniques. For instance, instead of having to issue a plurality of queries to different database tables, a single query may be issued to the graph database, which is then traversed based on nodes and edges included therein. Moreover, a single graph database may include metadata for a plurality of different users, content provider sources, metadata sources, and media content items. Accordingly, the techniques described herein improves the functioning of computers by reducing the number of queries to be issued to find media content items to recommend, thus reducing the processing required to determine such media content items, and further reducing the amount of storage required to maintain a relationship between users, content provider services and media content items.

Still further, in certain embodiments, a metadata source may be specific to a particular user. For instance, an end user device, such as a digital video recorder (DVR) located at the user's premises may serve as a metadata source. In another example, a user's watchlist may serve as a metadata source. The metadata from the DVR and/or watchlist may be incorporated into the graph database with metadata from other, centrally-located metadata sources. Thus, when determining media content items to be recommended to the user, the content items stored by the DVR and/or the items specified by the user's watchlist may be considered and/or prioritized, thereby tailoring the search specific to the user himself. Accordingly, the particular arrangement of the media content search system, which may utilize both centrally-located components and components local to a user, provides a technical improvement over the current state of the art for recommending media content items—in particular, more relevant, user-specific recommendations.

In particular, a computer-implemented method is described herein. The method includes: receiving first metadata associated with a first media content item from a first metadata source, the first metadata comprising an identifier of the first media content item and a first attribute that describes an aspect of the first media content item; generating a representation of the first media content item in a graph database by assigning the identifier of the first media content item to a first node, assigning the first attribute to a second node, and establishing a first edge between the first node and the second node, the first edge representing a relationship between the first media content item and the first attribute; receiving second metadata associated with a second media content item from a second metadata source that is different than the first metadata source, the second metadata comprising an identifier of the second media content item and a second attribute that describes an aspect of the second media content item; generating a representation of the second media content item in the graph database by assigning the identifier of the second media content item to a third node and establishing a second edge between the third node and the second node based on a determination that the second attribute is equivalent to the first attribute; receiving a query; based on the query, traversing the graph database from the second node to the first node via the first edge and from the second node to the third node via the second edge; and identifying the first media content item and the second media content item as being responsive to the query based on the traversal.

In accordance with one or more embodiments, the first metadata further comprises a third attribute that identifies a first content provider that provides the first media content item, and wherein the second metadata further comprises a fourth attribute that identifies a second content provider that provides the second media content item, the second content provider being different that the first content provider.

In accordance with one or more embodiments, the method further comprises: assigning the third attribute that identifies the first content provider to a fourth node in the graph database and establishing a third edge between the fourth node and the first node; assigning the fourth attribute that identifies the second content provider to a fifth node in the graph database and establishing a fourth edge between the fifth node and the third node; and based on the query, traversing the graph database to determine that the first media content item is available via the first content provider and that the second media content item is available via the second content provider.

In accordance with one or more embodiments, the first metadata source comprises one of and the second metadata source comprises another one of: an entertainment content metadata provider; a video content provider; a web-based information provider; an electronic program guide (EPG) data provider; an audio content provider; a digital video recorder; or a network-based content provider.

In accordance with one or more embodiments, receiving the first metadata comprises: sending a command to a switching device coupled to the digital video recorder that causes the switching device to query the digital video recorder for the first metadata; and receiving the first metadata from the switching device.

In accordance with one or more embodiments, the first attribute or the second attribute comprise: a user for which the first media content item or the second media content item are consumable; a program name for the first media content item or the second media content item; a watchlist associated with the user on which the first media content item or the second media content item is included; a channel on which the first media content item or the second media content item is provided; an airing time at which the first media content item or the second media content item airs; a genre of the first media content item or the second media content item; a credit associated with the first media content item or the second media content item; and a streaming service on which the first media content item or the second media content item is available for consumption.

In accordance with one or more embodiments, the method further comprises: formatting the first metadata and the second metadata into a common format suitable for the graph database.

A computing device is also described herein. The computing device comprises one or more processors and one or more memory devices connected to the one or more processors, the one or more memory devices storing computer program logic for execution by the one or more processors, the computer program logic including: a metadata receiver configured to: receive first metadata associated with a first media content item from a first metadata source, the first metadata comprising an identifier of the first media content item and a first attribute that describes an aspect of the first media content item; and receive second metadata associated with a second media content item from a second metadata source that is different than the first metadata source, the second metadata comprising an identifier of the second media content item and a second attribute that describes an aspect of the second media content item; a graph database builder configured to: generate a representation of the first media content item in a graph database by assigning the identifier of the first media content item to a first node, assigning the first attribute to a second node, and establishing a first edge between the first node and the second node, the first edge representing a relationship between the first media content item and the first attribute; and generate a representation of the second media content item in the graph database by assigning the identifier of the second media content item to a third node and establishing a second edge between the third node and the second node based on a determination that the second attribute is equivalent to the first attribute; and a content item retriever configured to: receive a query; based on the query, traverse the graph database from the second node to the first node via the first edge and from the second node to the third node via the second edge; and identify the first media content item and the second media content item as being responsive to the query based on the traversal.

In accordance with one or more embodiments, the first metadata further comprises a third attribute that identifies a first content provider that provides the first media content item, and wherein the second metadata further comprises a fourth attribute that identifies a second content provider that provides the second media content item, the second content provider being different that the first content provider.

In accordance with one or more embodiments, the graph database builder is further configured to: assign the third attribute that identifies the first content provider to a fourth node in the graph database and establishing a third edge between the fourth node and the first node; and assign the fourth attribute that identifies the second content provider to a fifth node in the graph database and establishing a fourth edge between the fifth node and the third node; and wherein the content item retriever is further configured to: based on the query, traverse the graph database to determine that the first media content item is available via the first content provider and that the second media content item is available via the second content provider.

In accordance with one or more embodiments, the first metadata source comprises one of and the second metadata source comprises another one of: an entertainment content metadata provider; a video content provider; a web-based information provider; an electronic program guide (EPG) data provider; an audio content provider; a digital video recorder; or a network-based content provider.

In accordance with one or more embodiments, the metadata receiver is further configured to: send a command to a switching device coupled to the digital video recorder that causes the switching device to query the digital video recorder for the first metadata; and receive the first metadata from the switching device.

In accordance with one or more embodiments, the first attribute or the second attribute comprise: a user for which the first media content item or the second media content item are consumable; a program name for the first media content item or the second media content item; a watchlist associated with the user on which the first media content item or the second media content item is included; a channel on which the first media content item or the second media content item is provided; an airing time at which the first media content item or the second media content item airs; a genre of the first media content item or the second media content item; a credit associated with the first media content item or the second media content item; and a streaming service on which the first media content item or the second media content item is available for consumption.

In accordance with one or more embodiments, the metadata receiver is further configured to: format the first metadata and the second metadata into a common format suitable for the graph database.

A computer-readable storage medium having program instructions recorded thereon that, when executed by at least one processor, perform a method for retrieving media content items is also described herein. The method includes receiving first metadata associated with a first media content item from a first metadata source, the first metadata comprising an identifier of the first media content item and a first attribute that describes an aspect of the first media content item; generating a representation of the first media content item in a graph database by assigning the identifier of the first media content item to a first node, assigning the first attribute to a second node, and establishing a first edge between the first node and the second node, the first edge representing a relationship between the first media content item and the first attribute; receiving second metadata associated with a second media content item from a second metadata source that is different than the first metadata source, the second metadata comprising an identifier of the second media content item and a second attribute that describes an aspect of the second media content item; generating a representation of the second media content item in the graph database by assigning the identifier of the second media content item to a third node and establishing a second edge between the third node and the second node based on a determination that the second attribute is equivalent to the first attribute; receiving a query; based on the query, traversing the graph database from the second node to the first node via the first edge and from the second node to the third node via the second edge; and identifying the first media content item and the second media content item as being responsive to the query based on the traversal.

In accordance with one or more embodiments, the first metadata further comprises a third attribute that identifies a first content provider that provides the first media content item, and wherein the second metadata further comprises a fourth attribute that identifies a second content provider that provides the second media content item, the second content provider being different that the first content provider.

In accordance with one or more embodiments, the method further comprises: assigning the third attribute that identifies the first content provider to a fourth node in the graph database and establishing a third edge between the fourth node and the first node; assigning the fourth attribute that identifies the second content provider to a fifth node in the graph database and establishing a fourth edge between the fifth node and the third node; and based on the query, traversing the graph database to determine that the first media content item is available via the first content provider and that the second media content item is available via the second content provider.

In accordance with one or more embodiments, the first metadata source comprises one of and the second metadata source comprises another one of: an entertainment content metadata provider; a video content provider; a web-based information provider; an electronic program guide (EPG) data provider; an audio content provider; a digital video recorder; or a network-based content provider.

In accordance with one or more embodiments, receiving the first metadata comprises: sending a command to a switching device coupled to the digital video recorder that causes the switching device to query the digital video recorder for the first metadata; and receiving the first metadata from the switching device.

In accordance with one or more embodiments, the first attribute or the second attribute comprise: a user for which the first media content item or the second media content item are consumable; a program name for the first media content item or the second media content item; a watchlist associated with the user on which the first media content item or the second media content item is included; a channel on which the first media content item or the second media content item is provided; an airing time at which the first media content item or the second media content item airs; a genre of the first media content item or the second media content item; a credit associated with the first media content item or the second media content item; and a streaming service on which the first media content item or the second media content item is available for consumption.

### III. GRAPH DATABASE FOR MEDIA CONTENT SEARCH AND RECOMMENDATIONS

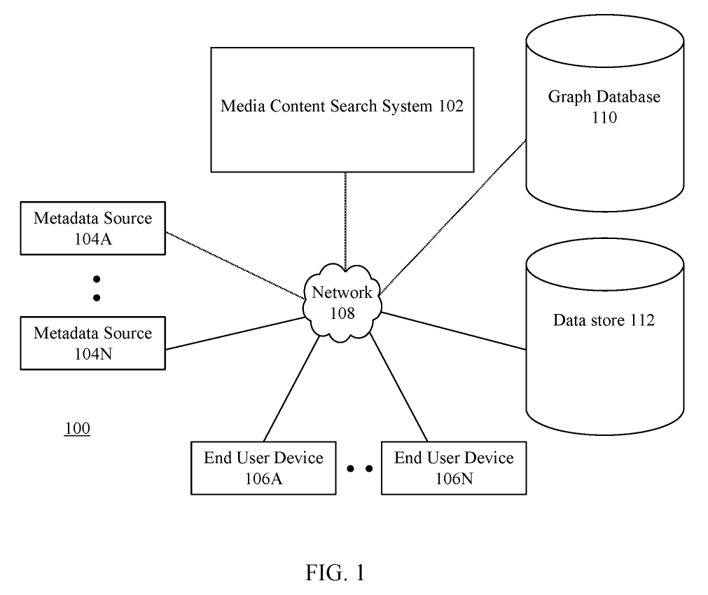

FIG. 1 depicts a system 100 that uses a graph database for enabling a media content search in accordance with an embodiment. As shown in FIG. 1, system 100 includes a media content search system 102, a plurality of metadata sources 104A-104N, a plurality of end user devices 106A-106N, a graph database 110, and a data store 112. It should be noted that there can be any number of end user devices and/or metadata sources present in system 100. Media content search system 102, metadata sources 104A-104N, end user devices 106A-106N, graph database 110, and data store 112 may all be communicatively coupled via a network 108. Network 108 may comprise one or more networks such as local area networks (LANs), wide area networks (WANs), enterprise networks, the Internet, etc., and may include one or more of wired and/or wireless communication links.

End user devices 106A-106N may be devices that enable users to interact with media content search system 102 and may include handheld devices as well as stationary devices. Examples of handheld devices include television remote controls, universal remotes, smart phones, tablet devices, and other devices that can be held in a person's hand or hands. Examples of stationary devices include televisions, set-top boxes, satellite TV receiver boxes, DVD players, DVRs, switching devices, and other devices too large to be easily carried by a human, and that are intended to operate in a stationary location. Each of end user devices 106A-106N may be interacted with by an end user to provide commands, queries, etc., in various ways, such as by a text input, a voice command, etc. Each of end user devices 106A-106N may be remotely located from media content search system 102 and/or located within the end user's premises (e.g., the living room, family room, bedroom, house, etc.). Each of end user devices 106A-106N may be connected to the same subnetwork (or “subnet”) that is communicatively coupled to network 108. Each of end user devices 106A-106N may be communicatively coupled to media content search system 102 via the subnet and network 108.

Each of metadata sources 104A-104N may be configured to store and/or provide metadata associated with a plurality of media content items. Examples of media content items may include, for example, a movie, a television (TV) show, or an episode of a TV show, but may also encompass audio content (e.g., albums, songs, podcasts), video games, software applications or any other type of media content. The media content items may be made available for user engagement (e.g., viewing and/or listening) via one or more content providers (e.g., media broadcasting services, such as, but not limited to, DirectTV™, AT&T™, Comcast™ and/or Internet streaming services, such as but not limited to Hulu™, Netflix™, HBO™, YouTube™, Amazon™, etc.). Each of metadata sources 104A-104N may be associated with content provider(s). Examples of metadata sources 104A-104N include, but are not limited to, an electronic programming guide (EPG) provider, one or more entertainment content metadata providers (e.g., Gracenote™, Rovi™, etc.), video content provider(s) (e.g., Hulu™, Netflix™, HBO™, Youtube™, Amazon™, etc.), web-based information provider(s) (e.g., IMDB™), and/or audio content provider(s) (e.g., Rhapshody™, Itunes™, Last.fm™, etc.). Furthermore, such media content metadata may be obtained from one or more of end user devices 106A-106N. Accordingly, one or more of end user devices 106A-106N may serve as metadata source in addition to and/or lieu of metadata sources 104A-104N. For example, metadata may be stored by a DVR or other recording device that stores recorded media content.

Media content search system 102 may be configured to receive metadata associated with media content items from metadata sources 104A-104N and/or end user devices 106A-106N. The metadata associated with each media content item may include information (or attributes) that identifies the media content item (e.g., an identifier that identifies a title of the media content item) and/or attributes that describe the item of media content. Examples of attributes include, but are not limited to, air time(s) and/or channel(s) on and/or at which the identified media content airs, a content service provider that provides the identified media content item (e.g., DirecTV™, Xfinity™, Dish Network™, AT&T™, etc.), an over-the-top service provider name (e.g., Netflix™, Vudu™, Amazon Video™ Hulu™, etc.), a genre or mood of the identified media content item (e.g., drama, comedy, sports, biography, funny, sad, etc.), a sports team and/or sports league associated with the identified media content item, one or more credits associated with the identified media content item (e.g., actor(s), director(s), producer(s), writer(s), etc.), an end user for which the identified media content item is available (e.g., a subscriber to the content provider, an end user associated with a DVR, etc.). It is noted that attributes described herein are purely exemplary and that metadata may include other attributes that may be assigned to nodes.

Media content search system 102 may be further configured to generate a representation of each identified media content item in graph database 110 based on the metadata attributes. Media content search system 102 may generate the representation of each identified media content item in graph database 110 by at least assigning each attribute to a node in graph database 110. Media content search system 102 may establish an edge between nodes in graph database 110. In an embodiment, an edge represents a relationship between the attributes represented by the edge-coupled nodes. The relationship between the attributes may include any of a variety of different relationships between attributes associated with an item of media content. For example, and without limitation, the relationship between two attributes may include a relationship between a content source and a channel and/or an airing time for the identified media content item, a program name (or media content item name) and a channel and/or an airing time for the identified media content item, a program and a genre for the identified media content item, a program name and a sports team name for the identified media content item, a program name and a league name for the identified media content item, a program name and an event (e.g., a concert, a sporting event, etc.), a program name and a credit for the identified media content name, or a program name and a service provider for the identified media content name. It is noted that relationships described herein are purely exemplary and that edges may be associated with other relationships.

Media content search system 102 may be configured to enable users of end user devices 106A-106N to perform a targeted, efficient search for media content using graph database 110. For example, and with reference to FIG. 1, a user may perform a search for a particular media content item using one of end user device(s) 106A-106N. For instance, the user may enter a voice-based query or enter a query using a graphical user interface (GUI) that is provided by the end user device and rendered on a display device coupled thereto. The end user device may process the input, determine search terms, and/or generate and transmit a query including such terms to media content search system 102 via network 108. Media content search system 102 may be configured to receive the query. In response to receiving the query, media content search system 102 may identify items of media content by traversing graph database 110 based on the query.

Media content search system 102 may traverse graph database 110 in various ways. In an embodiment, media content search system 102 traverses graph database 110 by identifying at least one attribute represented by a node of graph database 110 based on query terms of the query and utilizing the at least one attribute to identify a starting point (or starting node) for traversing graph database 110. For instance, suppose the query specifies a movie name as a search term. The node corresponding to the movie name may serve as the starting point for traversing the graph database. Other nodes coupled to that node via an edge may be utilized to find content providers that provide the content, channels and/or air times on and/or at the media content items air, other related media content items that the user may be interested, etc. Related media content items may be media content items that share a common attribute, such as the same actor, same director, same genre, etc.

Once a media content item and/or media content items related thereto are identified using graph database 110 based on the query, media content search system 102 may be configured to recommend such media content items for viewing by the user by returning information about and/or enabling playback of the media content item. For instance, media content search system 102 may provide a means for accessing the media content item (e.g., via a user-interactive link) and/or related media content items from a content provider or service for playback to the end user of the corresponding one of end user devices 106A-106N. The information returned may include, but is not limited to an image (e.g., a title card, a screenshot, etc.) associated the media content item, an abstract that briefly describes or provides a summary of the media content item, etc.

Data store 112 may store the means (e.g., a user-interactive link) for accessing the media content item and/or related media content items from a content provider or service for playback. Data store 112 may also store the information associated with media content items. When recommending media content items to the user, media content search system 102 may be configured to send a query that specifies identifier(s) of the media content item and/or related media content items. Data store 112 may be configured to retrieve the information associated with the media content item and/or related media content items specified by the identifier(s) and provide the information and/or means to access such media content items to media content search system 102. In response to receiving the information, media content search system 102 may provide the means for accessing the recommend media content items along with the information for the recommended media content items to the end user device. Alternatively, data store 112 may provide the means for accessing the recommended media content items and information associated therewith directly to the end user device via network 108.

It is noted that while graph database 110 and data store 112 are shown in FIG. 1 as being communicatively coupled to media content search system 102 via network 108, in certain embodiments, graph database 110 and/or data store 112 may be maintained locally to media content search system 102.

In accordance with an embodiment, media content search system 102 may provide recommendations for media content item without a user-initiated query (i.e., a query initiated at one of end user devices 106A-106N). For instance, media content search system 102 may periodically search for media content items that may be of interest to the user based on a media content item viewing history of the user (e.g., maintained at one of end user devices 106A-106N). In accordance with such an embodiment, media content search system 102 may automatically generate a query based on the media content item viewing history of the user and search for media content items to recommend to the user using graph database 110.

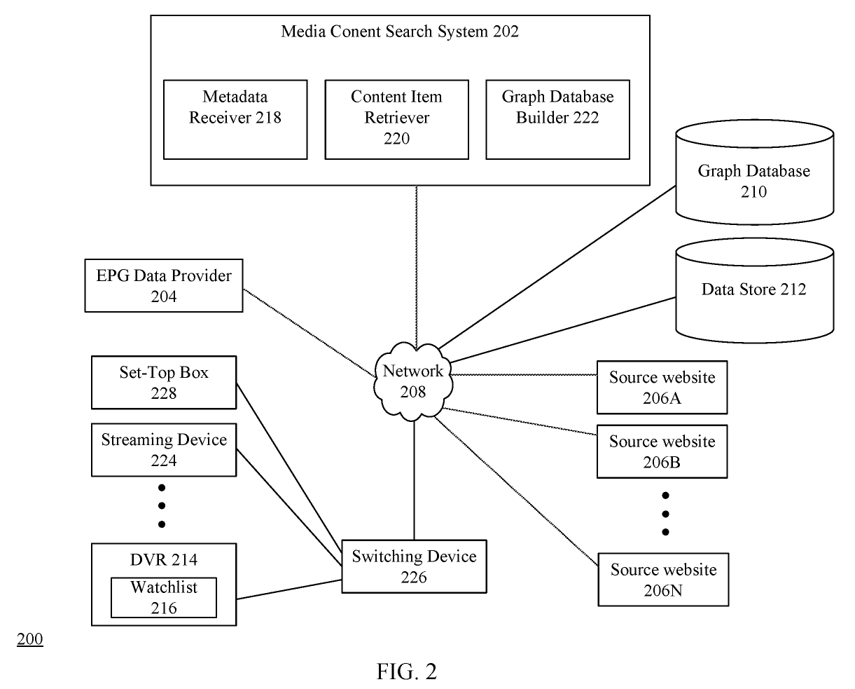

FIG. 2 depicts a system 200 that uses a graph database for enabling a media content search in accordance with another embodiment. As shown in FIG. 2, system 200 includes a media content search system 202, an EPG data provider 204, a plurality of source websites 206A-206N, a switching device 226, a set-top box 228, an Internet streaming device 224, a DVR 214, a graph database 210, and a data store 212. Media content search system 202 includes a metadata receiver 218, a content item retriever 220, and a graph database builder 222. Media content search system 202, graph database 210, and data store 212 are examples of media content search system 102, graph database 110, and data store 112, as respectively described above with reference to FIG. 1. EPG data provider 204 and source websites 206-206N are examples of metadata sources 104A-104N, as described above with reference to FIG. 1. Switching device 226, set-top box 228, Internet streaming device 224 and, DVR 214 are examples of end user devices 106A-106N, as described above with reference to FIG. 1. Each of switching device 226, DVR 214, Internet streaming device 224, set-top box 228 and/or other end user devices may be remotely located from media content search system 202 and/or located within the end user's premises. Each of switching device 226, DVR 214, set-top box 228, Internet streaming device 224 and/or other end user devices may be connected to the same subnet, which is communicatively coupled to network 108. Examples of Internet streaming device 224 include, but are not limited to a Roku™ device, an AppleTV™ device, a Chromecast™, an Amazon Fire™ device, and/or the like. Such devices may be configured to execute Internet streaming services (Netflix™, Amazon Video™, Hulu™, VUDU™, etc.). Switching device 226 may be coupled to switching device 226, DVR 214, Internet streaming device 224, set-top box 228 and/or other end user devices via a wired connection (e.g., a USB cable, an HDMI cable, an Ethernet cable, etc.) and/or a wireless connection (e.g., Wi-Fi, Bluetooth™, and/or the like). End user device may further include, but are not limited to, a media server (e.g., a Plex™ media server), a home personal computer (PC), and/or the like.

Media content search system 202, EPG data provider 204, graph database 210, data store 212, source websites 206A-206N, and switching device 226 are all communicatively coupled via a network 208. Other devices, such as set-top box 228, streaming device 224 and/or DVR 214 may also be coupled to network 208. Network 208 is an example of network 108, as described above with reference to FIG. 1.

Switching device 226 may be a switching device such as the HDMI switching device described in commonly-owned U.S. patent application Ser. No. 14/945,175, filed Nov. 18, 2015, and entitled “Seamless Setup and Control for Home Entertainment Devices and Content” and U.S. patent application Ser. No. 14/945,125, filed Nov. 18, 2015, and entitled “Automatic Identification and Mapping of Consumer Electronic Devices to Ports on an HDMI Switch”, the entireties of which is incorporated by reference herein. In accordance with such an embodiment, the HDMI switching device is connected to a television or other display device and provides a user interface through such display device by which a user can search for items of media content provided via end user devices coupled thereto (e.g., set-top box 228, Internet streaming device 224, DVR 214, and/or other devices).

EPG data provider 204 may be a system that provides data that is typically consumed by an EPG, which is an application that is used with digital cable and/or satellite set-top boxes (e.g., set-top box 228) and television sets to list current and scheduled programs that are or will be available on each channel and a short summary or commentary for each program. In embodiments, EPG data provider 204 may comprise a server or other entity that is accessed by metadata receiver 218 via network 208 or some other communication channel EPG data provider 204 may be configured to provide periodically-updated or intermittently-updated EPG data. The EPG data may be published by a variety of different media broadcasting entities, such as DirectTV®, AT&T®, Comcast®, or the like, although these examples are not intended to be limiting.

Each of source websites 206A-206N may comprise websites that are published by providers of media content (e.g., Netflix™, Hulu™, Amazon™, HBOGO™, etc.), providers of entertainment content metadata (e.g., Gracenote™, Rovi™, etc.), providers of video content (e.g., Hulu™, Netflix™, HBO™, Youtube™, Amazon™, etc.), providers of web-based information (e.g., IMDB™), providers of audio content (e.g., Rhapshody™, Itunes™, Last.fm™, etc.), and/or the like.

Metadata receiver 218 is configured to receive metadata associated with media content items different metadata sources (e.g., EPG data provider 204, DVR 214, source websites 206A-206C, etc.). Metadata received from a first metadata source may be in a different format than metadata received from another metadata source. Metadata receiver 218 may be configured to format (or normalize) received metadata into a common (or uniform) format suitable for graph database 210.

Metadata may also be stored and obtained from end user devices coupled to switching device 226 (e.g., set-top box 228, streaming device 224, DVR 214 (or other recording devices that store recorded media content) and/or other end user devices described herein). For instance, metadata receiver 218 may send a command to switching device 226 via network 208. The command may cause switching device 226 to issue a query to an end user device coupled thereto (e.g., DVR 214) for the metadata stored therein. In response to receiving the query, the end user device may issue a response to switching device 226 that includes the metadata. Switching device 226 may provide the received metadata to metadata receiver 218 via network 208. Alternatively, switching device 226 may periodically request metadata stored on end user devices coupled thereto and provide the metadata to metadata receiver 218 via network 208.

Graph database builder 222 is configured to extract attributes from the formatted metadata. Examples of attributes include, but are not limited to, an identifier that identifies the a title or program name of the media content item, air time(s) and/or channel(s) on and/or at which the identified media content airs, a media broadcasting entity that provides the identified media content item (e.g., DirecTV™, Comcast™, Dish Network™ AT&T™, etc.), an over-the-top service provider name that provides the identified media content item (e.g., Netflix™, Vudu™, Amazon Video™, Hulu™, etc.), a genre or mood of the identified media content item (e.g., drama, comedy, sports, biography, funny, sad, etc.), a sports team and/or sports league associated with the identified media content item, one or more credits associated with the identified media content item (e.g., actor(s), director(s), producer(s), writer(s), etc.), an end user for which the identified media content item is available (e.g., a subscriber to the content service provider, an end user associated with a DVR, etc.).

Graph database builder 222 may be further configured to generate a representation of each identified media content item in graph database 210. Graph database builder 222 may generate the representation of each identified media content item in graph database 210 by at least assigning each attribute to a node in graph database 210. Media content search system 202 may establish an edge between nodes in graph database 210. In an embodiment, an edge represents a relationship between the attributes represented by the edge-coupled nodes. The relationship between the attributes may include any of a variety of different relationships between attributes associated with an item of media content. For example, and without limitation, the relationship between two attributes may include a relationship between a content source and a channel and/or an airing time for the identified media content item, a program name (or media content item name) and a channel and/or an airing time for the identified media content item, a program and a genre for the identified media content item, a program name and a sports team name for the identified media content item, a program name and a league name for the identified media content item, a program name and an event (e.g., a concert, a sporting event, etc.), a program name and a credit for the identified media content name, or a program name and a service provider for the identified media content name.

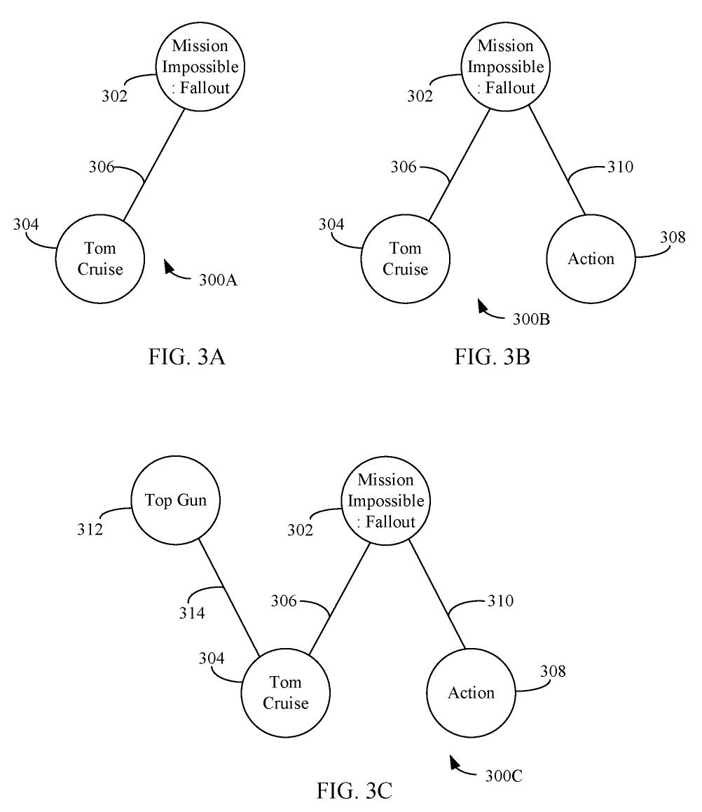

For instance, FIG. 3A depicts an example graph 300A of graph database 210 in accordance with an embodiment. Graph 300A may be generated based on metadata received via a first metadata source (e.g., source website 206A). The metadata may comprise a first attribute and a second attribute. The first attribute is an identifier that identifies the name of a movie (e.g., “Mission Impossible: Fallout”) and the second attribute identifies a credit (e.g., an actor name, such as “Tom Cruise”). Accordingly, graph database builder 222 assigns the identifier to a first node 302 and assigns the second attribute to a second node 304. Graph database builder 222 also establishes an edge 306 that couples first node 302 with second node 304. Edge 306 represents a relationship between the program (or movie) name and a credit for the movie (i.e., an actor's name).

In accordance with an embodiment, media content items having common identifier attributes (e.g., program or title name) and that are retrieved from different data sources may be represented by a single node. For instance, graph database builder 222 may determine whether metadata identifiers of a media content item from a first metadata source are equivalent (e.g., the same or similar) to identifiers a media content item from a second metadata source. In response to determining that two attributes from different metadata sources are equivalent, graph database builder 222 may generate a single node representative of that media content items. For instance, with reference to FIG. 3A, graph database builder 222 may determine that metadata received from another metadata source (e.g., DVR 214) also includes an identifier for “Mission Impossible: Fallout.” In response, graph database builder 222 may only generate a single node (i.e., node 302) representative of both identifiers because they identify the same movie.

Nodes may be generated for each of the attributes for that media content item retrieved from each metadata source. Such nodes may be coupled to the single node representative of that media content item. For example, FIG. 3B depicts an example graph 300B of graph database 210 in accordance with another embodiment. For instance, with reference to FIG. 3B, graph database builder 222 may determine that metadata received from a second metadata source (e.g., DVR 214) also includes an attribute for “Mission Impossible: Fallout” that was not included in the metadata from the first metadata source. For instance, the attribute may specify the genre of the movie. Accordingly, graph database builder 222 may assign the genre attribute (“action”) to a third node 308. Graph database builder 222 also establishes an edge 310 that couples first node 302 with third node 308. Edge 310 represents a relationship between the program (or movie) name and the genre of the movie (e.g., “action”). Accordingly, the attributes associated with a particular media content item may be expanded (i.e., metadata from one metadata source and metadata from another metadata source may all be associated with same media content item), thereby advantageously increasing the search terms that may be used to identify that media content item.

In accordance with an embodiment, media content items having equivalent (e.g., the same, similar, or common) attributes may be associated or linked together via graph database 210. For instance, suppose a first node is associated with an identifier of a first media content item (e.g., “Mission Impossible: Fallout”) and a second node is representative of an attribute that describes “Mission Impossible: Fallout” (e.g., an actor's name, such as “Tom Cruise”). Further suppose that a third node is associated with an identifier of a second media content item (e.g., “Top Gun”) and that an attribute of that media content is also “Tom Cruise.” In this case, the second node may be coupled to both the first node (i.e., “Mission Impossible: Fallout”) via a first edge and the third node (i.e., “Top Gun”) via a second edge. For instance, FIG. 3C depicts an example graph 300C of graph database 210 in accordance with another embodiment. As shown in FIG. 3C, suppose metadata received from another metadata source (e.g., EPG data provider 204) includes an identifier for another movie (e.g. “Top Gun”) and also includes an attribute that identifies a credit (e.g., an actor name, such as “Tom Cruise”). Accordingly, graph database builder 222 may assign the identifier to a fourth node 312. As described above, because the attribute “Tom Cruise” is common to another node representative of that attribute (i.e., second node 304), another node is not generated for “Tom Cruise.” Graph database builder 222 may establish an edge 314 between fourth node 312 and second node 304. Edge 314 represents a relationship between the program (or movie) name and a credit for the movie (i.e., an actor's name).

Content item retriever 220 may be configured to enable users of end user devices (e.g., switching device 226, set-top box 228, Internet streaming device 224, DVR 214, etc.) to perform a targeted, efficient search for media content by graph database 210. For example, and with reference to FIG. 2, a user may perform a search for a particular media content item using switching device 226. For instance, the user may enter a voice-based query or enter a query using a graphical user interface (GUI) that is provided by switching device 226 and rendered on a display device coupled thereto. Switching device 226 may process the input, determine search terms, and generate and transmit a search query including such terms to content item retriever 220 via network 208. Content item retriever 220 may be configured to receive the search query. In response to the search query, content item retriever 220 may identify items of media content by traversing graph database 210 based on the search query.

It is noted that a user may be able to perform searches via set-top box 228, streaming device 224 and/or DVR 214 in addition to and/or in lieu of switching device 226. For instance, search queries submitted by the end user via such devices may be passed by switching device 226 to content item retriever 220 and identified items of media content that are responsive to the search query are passed back to HDMI switching device 226 for display via the connected display device.

Content item retriever 220 may traverse graph database 210 in various ways. In an embodiment, content item retriever 220 traverses graph database 210 by identifying at least one attribute represented by a node of graph database 110 based on query terms of the query and utilizing the at least one attribute to identify a starting point for traversing the graph database. For instance, suppose the query specifies an actor name as a search term. The node corresponding to the actor name may serve as the starting point for traversing the graph database. Other nodes coupled to that node via an edge may be utilized to find content providers that provide the content, channels and/or air times on and/or at the media content items air, other related media content items that the user may be interested. Related media content items may be media content items that share a common attribute, such as the same actor, same director, same genre, etc.

Once a media content item and/or media content items related thereto are identified using graph database 210 based on the query, content item retriever 220 may be configured to recommend such media content items for viewing by the user by returning information about and/or enabling playback of the media content item. For instance, media content search system 202 may provide a means for accessing the media content item (e.g., via a user-interactive link) and/or related media content items from a content provider or service for playback to the end user via switching device 226. The information returned may include, but is not limited to an image (e.g., a title card, a screenshot, etc.) associated the media content item, an abstract that briefly describes or provides a summary of the media content item, etc.

Data store 212 may store a means (e.g., a user-selectable link) for accessing the media content item and/or related media content items from a content provider or service for playback and/or information associated with such media content items in similar manner as described above with reference to data store 112 of FIG. 1. When recommending media content items to the user, content item retriever 220 may be configured to send a query that specifies identifier(s) of the media content item and/or related media content items. Data store 212 may be configured to retrieve the information associated with the media content item and/or related media content items specified by the identifier(s) and provide the information and/or means to accessing such media content items to content item retriever 220. In response to receiving the information, content item retriever 220 may provide means for access the recommend media content items along with the information for the recommended media content items to the end user device. Alternatively, data store 212 may provide the means for accessing the recommended media content items and information associated therewith directly to switching device 226 via network 208. It is noted that the links and information associated with media content items may be stored in graph database 210 in addition to and/or in lieu of data store 212.

In accordance with an embodiment, a user may create a watchlist (e.g., watchlist 216) which includes a list of media content items that the user plans on engaging. The watchlist may be created using a watchlist program executing on an end user device and/or may be stored on the end user device. Alternatively, the watchlist program may be a web service that is accessible via an end user device and stored remotely. It is noted that while FIG. 2 depicts watchlist 216 as being created and/or stored via DVR 214, watchlists may be created and/or stored via other end user devices, such as, but not limited to, switching device 226, Internet streaming device 224, and set-top box 228.

Metadata receiver 218 may be configured to retrieve watchlist 216 by sending a command to switching device 226 via network 208. Switching device 226 may query DVR 214 for metadata associated with watchlist 216 in response to receiving the command Alternatively, switching device 226 may periodically query DVR 214 for metadata associated with watchlists maintained thereby. Upon receiving the metadata, switching device 226 may provide the metadata to metadata receiver 218 via network 208. Graph database builder 222 may incorporate the metadata into graph database 222. In particular, graph database builder 222 may generate a node that assigns a watchlist identifier (included in the metadata) thereto and may connect the node to other node(s) that identify media content items specified by the watchlist. When recommending content, content item retriever 220 may determine whether any of the determined media content to be recommended is on the user's watchlist 216 (e.g., by traversing edges coupled between nodes that identify media content items and nodes that identify watchlists). If a determination is made that the content is on the user's watchlist 216, content item retriever 220 may provide such content first, thereby providing users with recommendations customized to the user's watchlist 216.

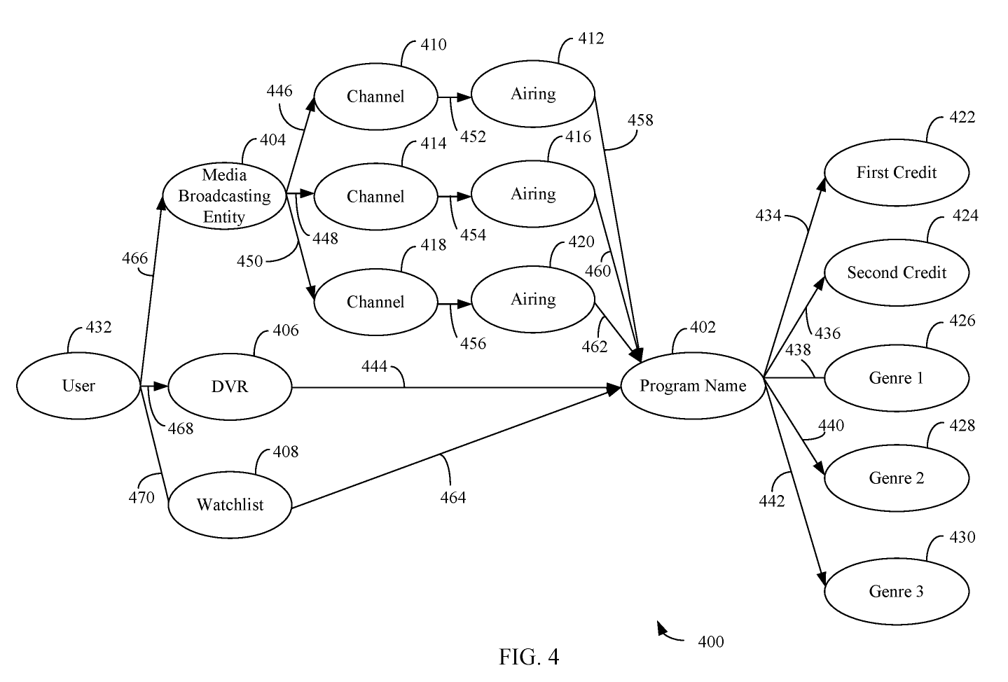

FIG. 4 depicts an example graph 400 of graph database 210 in accordance with another embodiment. As shown in FIG. 4, graph 400 includes nodes 402, 404, 406, 408, 410, 412, 414, 416, 418, 420, 422, 424, 426, 428, 430, and 432. Each of nodes 402, 404, 406, 408, 410, 412, 414, 416, 418, 420, 422, 424, 426, 428, 430, and 432 may correspond to an attribute of metadata collected from a variety of different metadata sources (e.g., metadata sources 104A-104N, end user devices 106A-106N, EPG data provider 204, source websites 206A-206N, set-top box 228, Internet streaming device 224, and/or DVR 214. For example, an identifier of a media content item retrieved from one or more metadata sources may be assigned to node 402 (“program name”) by graph database builder 222. As described above, the identifier may be included in different metadata received from different multiple metadata sources. As shown in FIG. 4, a single node (first node 402) is generated for that identifier.

As also shown in FIG. 4, a plurality of different nodes, each assigned to a particular attribute of the collected metadata, are coupled to node 402 via a plurality of edges. Such attributes may be from different metadata collected from different metadata sources. For instance, a first credit attribute (e.g., an actor name) associated with the media content item identified by node 402 is assigned to node 422, a second credit attribute (e.g., a director name) associated with the media content item identified by node 402 is assigned to node 424, a first genre (e.g., action) associated with the media content item identified by node 402 is assigned to node 426, a second genre (e.g., comedy) associated with the media content item identified by node 402 is assigned to node 428, and a third genre (e.g., adventure) associated with the media content item identified by node 402 is assigned to node 430. As an example, the first credit attribute and the second credit attribute may be obtained via a first metadata source (e.g., source website 206A), and the first genre attribute, second genre attribute, and the third genre attribute may be obtained via a second metadata source (e.g., EPG data provider 204). Edges 434 and 436 that respectively couple node 422 and node 424 to node 402 may represent a relationship between a program name and a credit for that program name Edges 438, 440, and 442 that respectively couple node 426, node 428, and node 430 to first node 402 may represent a relationship between a program name and a genre of that program name.

As further shown in FIG. 4, node 402 may be coupled to nodes that are assigned to a content provider attribute that identifies the content provider from which the media content item is available. For instance, if graph database builder 222 receives metadata that includes a content provider attribute that identifies EPG data provider 204 and includes an identifier that identifies the media content item, graph database builder 222 may generate node 404 and assign the content provider attribute thereto. If graph database builder 222 receives metadata that includes a content provider attribute that identifies DVR 214 and includes an identifier that identifies the media content item (meaning that the media content item is stored in DVR 214), graph database builder 222 may generate node 406 and assign the content provider attribute thereto. Edge 444 that couples node 406 to node 402 may represent a relationship between a content provider source (i.e. DVR 214) and the media content item represented by node 402.

Node 404 may further be coupled to nodes that specify the channel and/or air time at which the media content item airs, as specified by the metadata retrieved from EPG program provider 204. For instance, if graph database builder 222 receives metadata that includes channel attributes that identify the channels on which the media content airs, graph database builder 222 may generate corresponding nodes 410, 416, and 420, which are each assigned a corresponding channel attribute that identifies that channel on which the media content items air. Edges 446, 448, and 450 that respectively couple nodes 410, 414, and 418 to node 404 may represent a relationship between a content provider source and a channel on which the media content airs. If graph database builder 222 receives metadata that includes airing attributes that specify the times on the identified channel on which the media content airs, graph database builder 222 may generate corresponding nodes 412, 414, and 416, which are each assigned a corresponding airing attribute that identifies that time on which the media content items airs the channel represented by the node coupled thereto. Edge 452 that couples node 412 to node 410 may represent a relationship between a content provider source and a time at which the media content airs on the channel represented by node 410. Edge 454 that couples node 416 to node 414 may represent a relationship between a content provider source and a time at which the media content airs on the channel represented by node 414. Edge 456 that couples node 420 to node 418 may represent a relationship between a content provider source and a time at which the media content airs on the channel represented by node 418. Edge 458 that couples node 412 to node 402 may represent a relationship between the media content item and the airing time represented by node 412 for that media content item. Edge 460 that couples node 416 to node 402 may represent a relationship between the media content item and the airing time represented by node 416 for that media content item. Edge 462 that couples node 420 to node 402 may represent a relationship between the media content item and the airing time represented by node 420 for that media content item. The attributes assigned to nodes 404, 410, 412, 414, 416, 418, and 420 may be obtained from EPG data provider 204.

As further shown in FIG. 4, node 402 may be coupled to node 408 via an edge 464. Node 408 may be assigned to a watchlist attribute. The watchlist attribute may be obtained from an end user device that stores a watchlist (e.g., DVR 214). If graph database builder 222 receives metadata from the end user device that stores the watchlist and that specifies that the media content item represented by node 402 is included in the watchlist, graph database builder 222 may generate node 408 and assigns the watchlist attribute thereto. Edge 464 that couples node 408 and 402 may represent a relationship between the media content item and the watchlist (indicating that the media content item is included in a user's watchlist).

As further shown in FIG. 4, node 432 may be coupled to nodes 404, 406, and 408. Node 432 represents the user to which the content provider sources and/or watchlists are associated. For instance, if a particular user subscribes to particular content provider source and/or maintains a particular watchlist, graph database builder 222 may couple node 432 to the node that represents the content provider source or watchlist. In the example shown in FIG. 4, the user is associated with the media broadcasting entity represented by node 404, the DVR represented by node 406 and the watchlist associated with node 408. Accordingly, graph database builder 222 may couple node 432 to nodes 404, 406, and 408 with a corresponding edge 466, 468, and 470. Edges 466 and 468 that respectively couple node 432 to nodes 404 and 406 may represent a relationship between the user and the content providing sources associated with nodes 404 and 406. Edge 470 that respectively couples node 432 to node 408 may represent a relationship between the user and the watchlist associated with node 408.

In accordance with an embodiment, switching device 226 may determine the content providing sources and/or watchlists to which the user is associated. For instance, the user may create a profile via switching device 226 during a setup process. Switching device 226 may determine the content providing sources coupled thereto in accordance with embodiments described in aforementioned U.S. patent application Ser. No. 14/945,175 and U.S. patent application Ser. No. 14/945,125. Switching device 226 may provide metadata to metadata receiver 218 that associates the user with the content providing sources.

It is noted that graph 400 may be associated with a plurality of user nodes. Accordingly, a single graph 400 may be maintained in graph database 210 that includes metadata for a plurality of different users, content provider sources, and media content items. By doing so, the amount of storage required to maintain the relationship between users, content provider services and media content items is advantageously reduced.

When querying graph database 210 using a name of a media content item, the starting node may be node 402. To determine the content sources that provide the media content item, edges 458, 452, 446, 460, 454, 448, 462, 456, 450, 444, and 464 that respectively couple node 402 to nodes 404, 406, and 408 are traversed. To determine other related media content items to recommend, other nodes (not shown) that identify media content items that are also coupled to nodes 422, 425, 428, and 430 via corresponding edges may be traversed.

Using graph database 210 advantageously results in a much faster and efficient search for media content items than compared to other techniques, such as relational database-related techniques. For instance, instead of having to issue a plurality of queries to different database tables, a single query may be issued to graph database 210, which then determines the starting node for graph traversal. Once the starting node is determined, other related media content items may be quickly identified by traversing edges connected to the starting node. Moreover, because graph database 210 combines metadata from a plurality of different metadata sources (e.g., metadata sources 104A-104N, end user devices 106A-106N, EPG data provider 204, source websites 206A-206N, set-top box 228, streaming device 224, and/or DVR 214) and associates such metadata with common media content items, the same, single search conducted via graph database 210 may return media content item recommendations (and links for accessing such media content items) that are related to the search criteria specified by the query and for that are from completely different content providers.

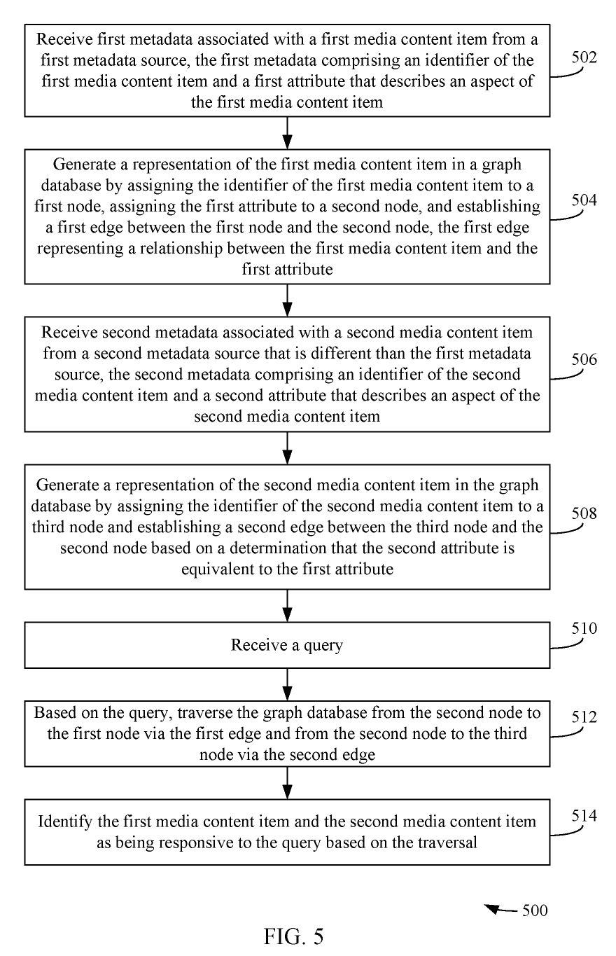

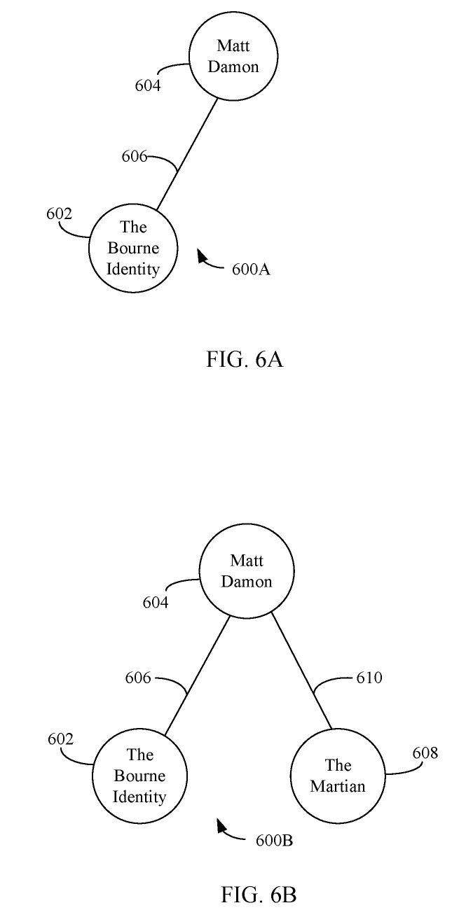

Accordingly, a graph database may be used to enable a media content search in many ways. For instance, FIG. 5 depicts a flowchart 500 of a method for using a graph database for enabling a media content search in accordance with an example embodiment. The method of flowchart 400 will be described with continued reference to system 200, as described above in reference to FIG. 2, and graphs 600A and 600B of FIGS. 6A and 6B. FIGS. 6A and 6B depicts graphs 600A and 600B of a graph database in accordance with example embodiments. Other structural and operational embodiments will be apparent to persons skilled in the relevant art(s) based on the following discussion regarding flowchart 500, system 200, and graphs 600A and 600B.

The method of flowchart 500 begins with step 502. In step 502, first metadata associated with a first media content item is received from a first metadata source. The first metadata comprises an identifier of the first media content item and a first attribute that describes an aspect of the first media content item. For example, with reference to FIG. 2, metadata receiver 218 receives first metadata associated with the first media content item from a first metadata source (e.g., EPG data provider 204).

In accordance with one or more embodiments, receiving the first metadata comprises sending a command to a switching device coupled to the digital video recorder that causes the switching device to query the digital video recorder for the first metadata and receiving the first metadata from the switching device. For example, with reference to FIG. 2, metadata receiver 218 may send a command to switching device 226 via network 208. Switching device 226 is coupled to DVR 214 (e.g., via an HDMI cable). The command may cause switching device 226 to query DVR 214 for the first metadata. Upon receiving the first metadata, switching device 226 may provide the first metadata to metadata receiver 218 via network 208.

In step 504, a representation of the first media content item is generated in a graph database by assigning the identifier of the first media content item to a first node, assigning the first attribute to a second node, and establishing a first edge between the first node and the second node, the first edge representing a relationship between the first media content item and the first attribute. For example, with reference to FIG. 2, graph database builder 222 may generate a representation of the first media content item in graph database 210 by assigning the identifier of the first media content item to a first node, assigning the first attribute to a second node, and establishing a first edge between the first node and the second node, the first edge representing a relationship between the first media content item and the first attribute. For instance, with reference to FIG. 6A. the identifier is a movie name (e.g., “The Bourne Identity”), and the first attribute specifies a credit for the movie (e.g., an actor name, “Matt Damon”). Accordingly, graph database builder 222 assigns the first identifier to a first node 602, assigns the first attribute to a second node 604, and establishes a first edge 606 between first node 602 and second node 604 that represents a relationship between the name of the movie and a credit for that movie.

In step 506, second metadata associated with a second media content item is received from a second metadata source that is different than the first metadata source. The second metadata comprises an identifier of the second media content item and a second attribute that describes an aspect of the second media content item. For example, with reference to FIG. 2, metadata receiver 218 receives second metadata associated with the second media content item from a second metadata source (e.g., source website 206A).

In step 508, a representation of the second media content item is generated in the graph database by assigning the identifier of the second media content item to a third node and establishing a second edge between the third node and the second node based on a determination that the second attribute is equivalent to the first attribute. For example, with reference to FIG. 2, graph database builder 222 may generate a representation of the second media content item in the graph database by assigning the identifier of the second media content item to a third node and establishing a second edge between the third node and the second node based on a determination that the second attribute is equivalent to the first attribute. For instance, with reference to FIG. 6B. the identifier of the second media content is a movie name (e.g., “The Martian”), and the second attribute specifies a credit for the movie that is equivalent to the first attribute (e.g., an actor name, “Matt Damon”). Accordingly, graph database builder 222 assigns the second identifier to a third node 608 and establishes a second edge 610 between third node 608 and second node 604. Second edge 610 represents a relationship between the name of the movie and a credit for that movie.

In step 510, a query is received. For example, with reference to FIG. 2, content item retriever 220 may receive (or, alternatively, generate) a query for a media content item. The query may be initiated by content item retriever 220 and/or an end user device, such as switching device 226.

In step 512, based on the query, the graph database is traversed from the second node to the first node via the first edge and from the second node to the third node via the second edge. For example, with reference to FIG. 2, graph database 210 is traversed from the second node to the first node via the first edge and from the second node to the third node via the second edge. For example, with reference to FIG. 6B, the query may include a search term “Matt Damon” (e.g., the user is interested in watching a movie that stars Matt Damon). In such an example, the starting node for traversal is second node 604. Second node 604 is traversed to first node 602 via first edge 606 to determine a first movie that stars Matt Damon (i.e., “The Bourne Identity”), and second node 604 is traversed to third node 608 via second edge 610 to determine a second movie that stars Matt Damon (i.e., “The Martian”).

In step 514, the first media content item and the second media content item are identified as being responsive to the query based on the traversal. For instance, with reference to FIG. 2, graph database 210 identifies the first media content item and the second media content item as being responsive to the query based on the traversal. For example, with reference to FIG. 6B. “The Bourne Identity” and “The Martian” are identified as being responsive to the query based on the traversal.

In accordance with one or more embodiments, the first metadata source comprises one of and the second metadata source comprises another one of an entertainment content metadata provider, a video content provider, a web-based information provider, an electronic program guide (EPG) data provider, an audio content provider, a digital video recorder, or a network-based content provider.

In accordance with one or more embodiments, the first attribute or the second attribute comprises a user for which the first media content item or the second media content item are consumable, a program name for the first media content item or the second media content item, a watchlist associated with the user on which the first media content item or the second media content item is included, a channel on which the first media content item or the second media content item is provided, an airing time at which the first media content item or the second media content item airs, a genre of the first media content item or the second media content item, a credit associated with the first media content item or the second media content item, and a streaming service on which the first media content item or the second media content item is available for consumption.

In accordance with one or more embodiments, the method further comprises formatting the first metadata and the second metadata into a common format suitable for the graph database. For example, with reference to FIG. 2, metadata receiver 218 formats the first metadata and the second metadata into a common format suitable for the graph database.

In accordance with one or more embodiments, the first metadata further comprises a third attribute that identifies a first content provider that provides the first media content item, and the second metadata further comprises a fourth attribute that identifies a second content provider that provides the second media content item, the second content provider being different that the first content provider.

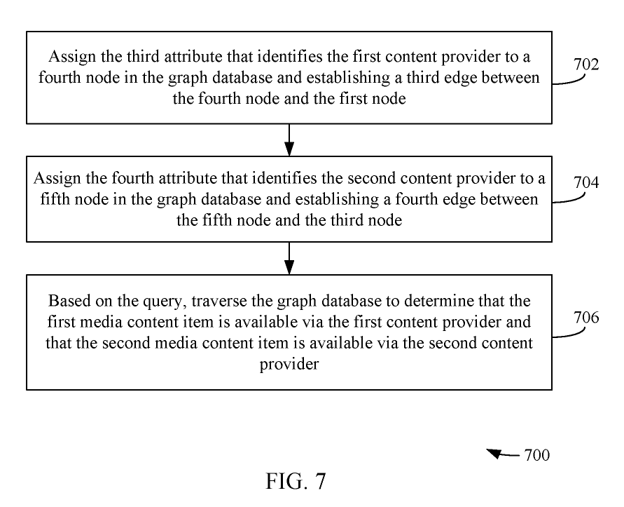

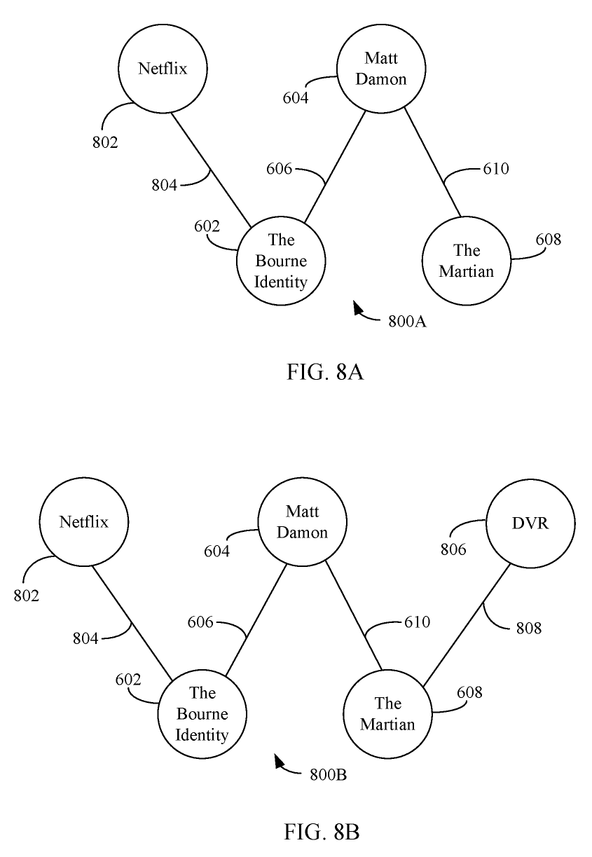

In accordance with one or more embodiments, the graph traversal identifies a plurality of different content providers that provide the identified media content items. For example, FIG. 7 depicts a flowchart 700 of a method for using a graph database to identify content providers for media content items in accordance with an example embodiment. The method of flowchart 700 will be described with continued reference to system 200, as described above in reference to FIG. 2, and graphs 800A and 800B of FIGS. 8A and 8B. FIGS. 8A-8B depict graphs 800A and 800B of a graph database in accordance with example embodiments. Graphs 800A and 800B are generated based on graph 600B, as shown in FIG. 6B. Other structural and operational embodiments will be apparent to persons skilled in the relevant art(s) based on the following discussion regarding flowchart 700, system 200, and graphs 800A and 800B.

The method of flowchart 700 begins with step 702. In step 702, the third attribute that identifies the first content provider is assigned to a fourth node in the graph database and a third edge between the fourth node and the first node is established. For example, with reference to FIG. 2, graph database builder 222 assigns the third attribute to a fourth node and establishes a third edge between the fourth node and the first node. For instance, with reference to FIG. 8A, the third attribute that identifies the content provider (e.g., Netflix™) of the first media content identifier is assigned to a fourth node 802 by graph database builder 222. Graph database builder 222 also establishes a third edge 804 between fourth node 802 and first node 602.

In step 704, the fourth attribute that identifies the second content provider is assigned to a fifth node in the graph database and a fourth edge between the fifth node and the third node is established. For example, with reference to FIG. 2, graph database builder 222 assigns the fourth attribute to a fifth node and establishes a fourth edge between the fifth node and the third node. For instance, with reference to FIG. 8B, the fourth attribute that identifies the content provider (e.g., DVR) of the second media content identifier is assigned to a fifth node 806 by graph database builder 222. Graph database builder 222 also establishes a fourth edge 808 between fifth node 806 and third node 608.

In step 706, based on the query, the graph database is traversed to determine that the first media content item is available via the first content provider and that the second media content item is available via the second content provider. For example, with reference to FIG. 2, graph database 210 is traversed to determine that the first media content item is available via the first content provider and that the second media content item is available via the second content provider. For instance, with reference to FIG. 8B, after identifying “The Bourne Identity” as the first media content item, first node 602 is traversed to fourth node 802 via third edge 804 to determine the first content provider (e.g., Netflix™ that provides “The Bourne Identity”), and third node 608 is traversed to fifth node 806 via fourth edge 808 to determine the second content provider (DVR) that provides “The Martian”).

### IV. EXAMPLE COMPUTER SYSTEM IMPLEMENTATION

One or more embodiments described herein may perform their functions according to the flowcharts described herein. Additional structural and operational embodiments will be apparent to persons skilled in the relevant art(s) based on the discussions regarding the flowcharts and embodiments herein. In some example embodiments, one or more of the steps of the described flowcharts may not be performed. Moreover, steps in addition to or in lieu of the steps of the described flowcharts may be performed (some of which were described above). Further, in some example embodiments, one or more of the steps of the described flowcharts may be performed out of the order shown or described, in an alternate sequence, and/or partially (or completely) concurrently with other steps.

Each of the components of system 100 of FIG. 1 (e.g. media content search system 102, metadata sources 104A-104N, end user devices 106A-106N, graph database 110 and/or data store 112) and system 200 of FIG. 2 (e.g., media content search system 202, metadata receiver 218, content item retriever 220, graph database builder 222, EPG data provider 204, set-top box 12, streaming device 224, DVR 214, switching device 226, graph database 210 and/or data store 212) and/or any sub-components included therein may be implemented in hardware, or any combination of hardware with software and/or firmware. For example, each of the components of system 100 of FIG. 1 and system 200 of FIG. 2 and/or any sub-components included therein may be implemented as computer program code configured to be executed in one or more processors. In another example, each of the components of system 100 of FIG. 1 and system 200 of FIG. 2 and/or any sub-components included therein may be implemented as hardware (e.g., hardware logic/electrical circuitry), or any combination of hardware with software (computer program code configured to be executed in one or more processors or processing devices) and/or firmware.

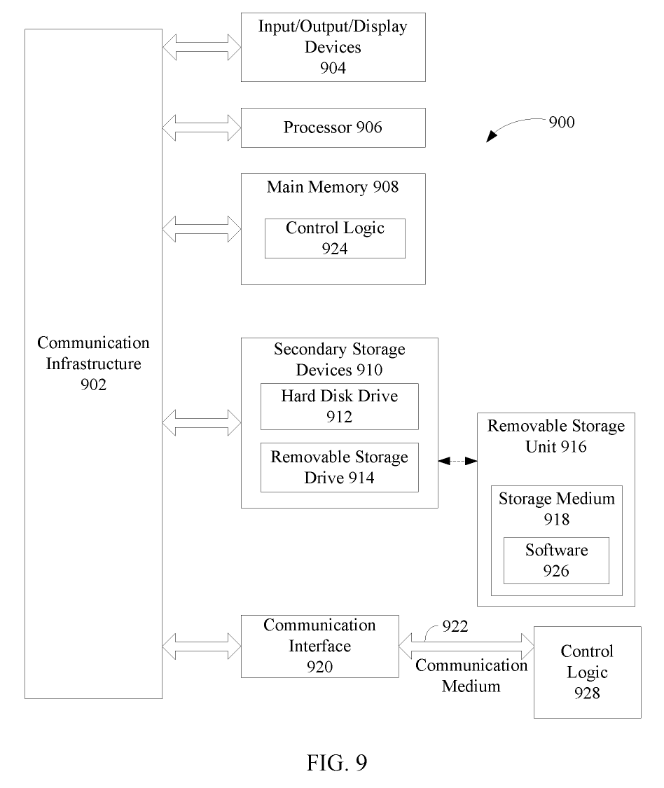

The embodiments described herein, including systems, methods/processes, devices, and/or apparatuses, may be implemented using well known processing devices, telephones (smart phones and/or mobile phones), tablet computers, servers, and/or, computers, such as a computer 900 shown in FIG. 9. It should be noted that computer 900 may represent communication devices, processing devices, servers, and/or traditional computers in one or more embodiments. For example, media content search system 102, media content search system 202, metadata receiver 218, content item retriever 220, graph database builder 222, flowchart 500, flowchart 700, and graphs 300A-300C, 400, 600A-600B, and 800A-800B, and any of the sub-systems or components respectively contained therein, may be implemented using one or more computers 900 or portions thereof.

Computer 900 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 900 may be any type of computer, including a desktop computer, a server, etc.

Computer 900 includes one or more processors (also called central processing units, or CPUs), such as a processor 906. Processor 906 is connected to a communication infrastructure 902, such as a communication bus. In some embodiments, processor 906 can simultaneously operate multiple computing threads.

Computer 900 also includes a primary or main memory 908, such as random access memory (RAM). Main memory 908 has stored therein control logic 924 (computer software), and data.

Computer 900 also includes one or more secondary storage devices 910. Secondary storage devices 910 include, for example, a hard disk drive 912 and/or a removable storage device or drive 914, as well as other types of storage devices, such as memory cards and memory sticks. For instance, computer 900 may include an industry standard interface, such a universal serial bus (USB) interface for interfacing with devices such as a memory stick. Removable storage drive 914 represents a floppy disk drive, a magnetic tape drive, a compact disk drive, an optical storage device, tape backup, etc.

Removable storage drive 914 interacts with a removable storage unit 916. Removable storage unit 916 includes a computer useable or readable storage medium 918 having stored therein computer software 926 (control logic) and/or data. Removable storage unit 916 represents a floppy disk, magnetic tape, compact disk, DVD, optical storage disk, or any other computer data storage device. Removable storage drive 914 reads from and/or writes to removable storage unit 916 in a well-known manner

Computer 900 also includes input/output/display devices 904, such as touchscreens, LED and LCD displays, monitors, keyboards, pointing devices, etc.

Computer 900 further includes a communication or network interface 918. Communication interface 920 enables computer 900 to communicate with remote devices. For example, communication interface 920 allows computer 900 to communicate over communication networks or mediums 922 (representing a form of a computer useable or readable medium), such as LANs, WANs, the Internet, etc. Network interface 920 may interface with remote sites or networks via wired or wireless connections.

Control logic 928 may be transmitted to and from computer 900 via the communication medium 922.

Any apparatus or manufacture comprising a computer useable or readable medium having control logic (software) stored therein is referred to herein as a computer program product or program storage device. This includes, but is not limited to, computer 900, main memory 908, secondary storage devices 910, and removable storage unit 916. Such computer program products, having control logic stored therein that, when executed by one or more data processing devices, cause such data processing devices to operate as described herein, represent embodiments described herein.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include, a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the figures, as well as any and all components, capabilities, and functions therein and/or further embodiments described herein.

Such computer-readable storage media are distinguished from and non-overlapping with communication media and transitory signals (do not include communication media and transitory signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The techniques and embodiments described herein may be implemented as, or in, various types of devices. For instance, embodiments may be included, without limitation, in processing devices (e.g., illustrated in FIG. 9) such as computers and servers, as well as communication systems such as switches, routers, gateways, and/or the like, communication devices such as smart phones, home electronics, gaming consoles, entertainment devices/systems, etc. A device, as defined herein, is a machine or manufacture as defined by 35 U.S.C. § 101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 906 of FIG. 9), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### V. CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A computer-implemented method, comprising:
receiving first metadata associated with a first media content item from a first metadata source, the first metadata comprising an identifier of the first media content item and a first attribute that describes an aspect of the first media content item;
generating a representation of the first media content item in a graph database by assigning the identifier of the first media content item to a first node, assigning the first attribute to a second node, and establishing a first edge between the first node and the second node, the first edge representing a relationship between the first media content item and the first attribute;
receiving second metadata associated with a second media content item from a second metadata source that is different than the first metadata source, the second metadata comprising an identifier of the second media content item and a second attribute that describes an aspect of the second media content item;
generating a representation of the second media content item in the graph database by assigning the identifier of the second media content item to a third node and establishing a second edge between the third node and the second node based on a determination that the second attribute is equivalent to the first attribute;
receiving a query;
based on the query, traversing the graph database from the second node to the first node via the first edge and from the second node to the third node via the second edge; and
identifying the first media content item and the second media content item as being responsive to the query based on the traversal.

2. The method of claim 1, wherein the first metadata further comprises a third attribute that identifies a first content provider that provides the first media content item, and wherein the second metadata further comprises a fourth attribute that identifies a second content provider that provides the second media content item, the second content provider being different that the first content provider.

3. The method of claim 2, further comprising:
assigning the third attribute that identifies the first content provider to a fourth node in the graph database and establishing a third edge between the fourth node and the first node;
assigning the fourth attribute that identifies the second content provider to a fifth node in the graph database and establishing a fourth edge between the fifth node and the third node; and
based on the query, traversing the graph database to determine that the first media content item is available via the first content provider and that the second media content item is available via the second content provider.

4. The method of claim 1, wherein the first metadata source comprises one of and the second metadata source comprises another one of:
an entertainment content metadata provider;
a video content provider;
a web-based information provider;
an electronic program guide (EPG) data provider;
an audio content provider;
a digital video recorder; or
a network-based content provider.

5. The method of claim 4, wherein receiving the first metadata comprises:
sending a command to a switching device coupled to the digital video recorder that causes the switching device to query the digital video recorder for the first metadata; and
receiving the first metadata from the switching device.

6. The method of claim 1, wherein the first attribute or the second attribute comprise:
a user for which the first media content item or the second media content item are consumable;
a program name for the first media content item or the second media content item;
a watchlist associated with the user on which the first media content item or the second media content item is included;
a channel on which the first media content item or the second media content item is provided;
an airing time at which the first media content item or the second media content item airs;
a genre of the first media content item or the second media content item;
a credit associated with the first media content item or the second media content item; and
a streaming service on which the first media content item or the second media content item is available for consumption.

7. The method of claim 1, further comprising:
formatting the first metadata and the second metadata into a common format suitable for the graph database.

8. A computing device, comprising:
one or more processors; and
one or more memory devices connected to the one or more processors, the one or more memory devices storing computer program logic for execution by the one or more processors, the computer program logic including:
a metadata receiver configured to:
receive first metadata associated with a first media content item from a first metadata source, the first metadata comprising an identifier of the first media content item and a first attribute that describes an aspect of the first media content item; and
receive second metadata associated with a second media content item from a second metadata source that is different than the first metadata source, the second metadata comprising an identifier of the second media content item and a second attribute that describes an aspect of the second media content item;
a graph database builder configured to:
generate a representation of the first media content item in a graph database by assigning the identifier of the first media content item to a first node, assigning the first attribute to a second node, and establishing a first edge between the first node and the second node, the first edge representing a relationship between the first media content item and the first attribute; and
generate a representation of the second media content item in the graph database by assigning the identifier of the second media content item to a third node and establishing a second edge between the third node and the second node based on a determination that the second attribute is equivalent to the first attribute; and
a content item retriever configured to:
receive a query;
based on the query, traverse the graph database from the second node to the first node via the first edge and from the second node to the third node via the second edge; and
identify the first media content item and the second media content item as being responsive to the query based on the traversal.

9. The computing device of claim 8, wherein the first metadata further comprises a third attribute that identifies a first content provider that provides the first media content item, and wherein the second metadata further comprises a fourth attribute that identifies a second content provider that provides the second media content item, the second content provider being different that the first content provider.

10. The computing device of claim 9, wherein the graph database builder is further configured to:
assign the third attribute that identifies the first content provider to a fourth node in the graph database and establishing a third edge between the fourth node and the first node; and
assign the fourth attribute that identifies the second content provider to a fifth node in the graph database and establishing a fourth edge between the fifth node and the third node; and
wherein the content item retriever is further configured to:
based on the query, traverse the graph database to determine that the first media content item is available via the first content provider and that the second media content item is available via the second content provider.

11. The computing device of claim 8, wherein the first metadata source comprises one of and the second metadata source comprises another one of:
an entertainment content metadata provider;
a video content provider;
a web-based information provider;
an electronic program guide (EPG) data provider;
an audio content provider;
a digital video recorder; or
a network-based content provider.

12. The computing device of claim 11, wherein the metadata receiver is further configured to:
send a command to a switching device coupled to the digital video recorder that causes the switching device to query the digital video recorder for the first metadata; and
receive the first metadata from the switching device.

13. The computing device of claim 8, wherein the first attribute or the second attribute comprise:
a user for which the first media content item or the second media content item are consumable;
a program name for the first media content item or the second media content item;
a watchlist associated with the user on which the first media content item or the second media content item is included;
a channel on which the first media content item or the second media content item is provided;
an airing time at which the first media content item or the second media content item airs;
a genre of the first media content item or the second media content item;
a credit associated with the first media content item or the second media content item; and
a streaming service on which the first media content item or the second media content item is available for consumption.

14. The computing device of claim 8, wherein the metadata receiver is further configured to:
format the first metadata and the second metadata into a common format suitable for the graph database.

15. A computer-readable storage medium having program instructions recorded thereon that, when executed by at least one processor, perform a method for retrieving media content items, the method comprising:
receiving first metadata associated with a first media content item from a first metadata source, the first metadata comprising an identifier of the first media content item and a first attribute that describes an aspect of the first media content item;
generating a representation of the first media content item in a graph database by assigning the identifier of the first media content item to a first node, assigning the first attribute to a second node, and establishing a first edge between the first node and the second node, the first edge representing a relationship between the first media content item and the first attribute;
receiving second metadata associated with a second media content item from a second metadata source that is different than the first metadata source, the second metadata comprising an identifier of the second media content item and a second attribute that describes an aspect of the second media content item;
generating a representation of the second media content item in the graph database by assigning the identifier of the second media content item to a third node and establishing a second edge between the third node and the second node based on a determination that the second attribute is equivalent to the first attribute;
receiving a query;
based on the query, traversing the graph database from the second node to the first node via the first edge and from the second node to the third node via the second edge; and
identifying the first media content item and the second media content item as being responsive to the query based on the traversal.

16. The computer-readable storage medium of claim 15, wherein the first metadata further comprises a third attribute that identifies a first content provider that provides the first media content item, and wherein the second metadata further comprises a fourth attribute that identifies a second content provider that provides the second media content item, the second content provider being different that the first content provider.

17. The computer-readable storage medium of claim 16, the method further comprising:
assigning the third attribute that identifies the first content provider to a fourth node in the graph database and establishing a third edge between the fourth node and the first node;
assigning the fourth attribute that identifies the second content provider to a fifth node in the graph database and establishing a fourth edge between the fifth node and the third node; and
based on the query, traversing the graph database to determine that the first media content item is available via the first content provider and that the second media content item is available via the second content provider.

18. The computer-readable storage medium of claim 15, wherein the first metadata source comprises one of and the second metadata source comprises another one of:
an entertainment content metadata provider;
a video content provider;
a web-based information provider;
an electronic program guide (EPG) data provider;
an audio content provider;
a digital video recorder; or
a network-based content provider.

19. The computer-readable storage medium of claim 18, wherein receiving the first metadata comprises:
sending a command to a switching device coupled to the digital video recorder that causes the switching device to query the digital video recorder for the first metadata; and
receiving the first metadata from the switching device.

20. The computer-readable storage medium of claim 15, wherein the first attribute or the second attribute comprise:
a user for which the first media content item or the second media content item are consumable;
a program name for the first media content item or the second media content item;
a watchlist associated with the user on which the first media content item or the second media content item is included;
a channel on which the first media content item or the second media content item is provided;
an airing time at which the first media content item or the second media content item airs;
a genre of the first media content item or the second media content item;
a credit associated with the first media content item or the second media content item; and
a streaming service on which the first media content item or the second media content item is available for consumption.
